(19) United States
(12) Patent Application Publication
(10) Pub. No.: US 2009/0303858 A1
(43) Pub. Date: Dec. 10, 2009

(54) OPTICAL RECORDING HEAD, MAGNETO-OPTICAL RECORDING HEAD AND OPTICAL RECORDING APPARATUS

(75) Inventors: Manami Kuiseko, Kyoto-shi (JP); Hiroaki Ueda, Suita-shi (JP); Naoki Nishida, Kusatsu-shi (JP); Kenji Konno, Sakai-shi (JP); Koujirou Sekine, Ibaraki-shi (JP); Masahiro Okitsu, Higashiosaka-shi (JP); Hiroshi Hatano, Takatsuki-shi (JP)

Correspondence Address: SIDLEY AUSTIN LLP, 717 NORTH HARWOOD, SUITE 3400, DALLAS, TX, 75201, US

(73) Assignee: Konica Minolta Opto, Inc., Hachioi-shi (JP)

(21) Appl. No.: 12/300,353

(22) PCT Filed: May 11, 2007
(86) PCT No.: PCT/JP2007/059736

§ 371 Date: Nov. 11, 2008

(30) Foreign Application Priority Data
May 16, 2006 (JP) 2006-136273

(51) Int. Cl. G11B 7/135

(52) U.S. Cl. 369/112.27; G9B/7

(57) ABSTRACT

An optical recording head simply structured, enabling a reduction in thickness, and having sufficient efficiency even if a light source with small output is used when a plasmon probe is used. The optical recording head includes a light source section for emitting light, a slider moving relative to a recording medium, and an optical waveguide disposed in the slider, guiding the light from the light source section and irradiating the surface of the recording medium with the light, and having a light emission angle not perpendicular to the surface, of the slider, facing the surface of the recording medium.

### TECHNICAL FIELD

The present invention relates to an optical recording head, magneto-optical recording head and optical recording apparatus.

### BACKGROUND ART

In the magnetic recording system with a higher recording density, the magnetic bit is seriously affected by the external temperature and others. This requires use of a recording medium having a high coercive force. Use of such a recording medium leads to an increase in the magnetic field required for recording. The magnetic field generated by the recording head has an upper limit determined by the saturation magnetic flux density. This saturation magnetic flux density has already come very close to the limit on a material basis, and a drastic increase cannot be expected. To address this problem, proposed is a method in which magnetic weakening is caused by local heating at the time of recording to reduce the coercive force, and the recording is performed when the coercive force is reduced, after that, heating is terminated to allow natural cooling, and stability of the recorded magnetic bit is thus ensured. This proposed technique is referred to as a heat-assisted magnetic recording method.

In the heat-assisted magnetic recording method, heating of the recording medium is preferably instantaneously performed. A heating mechanism is not allowed to contact the recording medium. For this reason, it is a common practice to use absorption of light for heating. The method of using light for heating is referred to as a light-assisted method. The following introduces a method of irradiating the magnetic recording surface with a laser beam.

One end of a rod-like flexible optical waveguide is provided with a reflection surface that reflects, in the direction of passing through the clad, a part of the light transmitted within the core of the optical waveguide. Then a light shielding film is formed on the surface of the clad which is centering on the site where the light having been reflected by the reflection surface goes through. A part of the light shielding film corresponding to the site where the light having been reflected by the reflection surface goes through is removed to form an opening smaller than the wavelength of the light to be used. This structure provides a cantilever beam type optical pickup device capable of emitting near-field light from the lower surface of the front end of the rod-like optical waveguide, as shown in the Patent Document 1.

When the light-assisted magnetic recording method is used to perform super high density recording, the required spot diameter is of the order of 20 nm. The conventional optical system is incapable of converge light to that extent due to the limit of diffraction. Therefore, there have been proposed several methods in which near-field light is used as non-propagation light for heating (Patent Document 2). In these method, a laser beam having an appropriate wavelength is converged by an optical system, and is applied to a metal having a size of several tens of nanometers (referred to as a plasmon probe), whereby near-field light is generated, and the near-field light is used as a heating section.

Regarding the aforementioned plasmon probe it is known that a surface excitation plasmon (near-field light) can be generated on the surface of a thin metal film (Patent Document 1). The surface excitation plasmon is characterized in that (1) electrons are excited when an electromagnetic wave (light) is applied from the dielectric side at an oblique angle; and (2) the electromagnetic wave (polariton) to be coupled by the generated plasmon (electron oscillation) is greater than the amplitude of the incident electromagnetic wave in some cases. Accordingly, it is supposed that if the surface-excitation plasmon is generated, the amplified electric field is produced, and the light usage efficiency can thus be increased to a considerable extent. The incident angle onto the thin metal film from the dielectric side is said to be preferably equal to or greater than the critical angle so as to ensure complete reflection on the exit side.

Patent Document 1: Unexamined Japanese Patent Application Publication No. 2000-215494

Patent Document 2: Unexamined Japanese Patent Application Publication No. 2005-116155

Non-Patent Document 1: Surface Plasmons on Smooth and Rough Surfaces and in Gratings/Springer (1988)/H. Raether

### DISCLOSURE OF THE INVENTION

### Object of the Invention

However, as shown in the Patent Documents 1 and 2, the light beam in the direction perpendicular to the irradiated surface has been used as the light beam irradiating the recording surface in the conventional art. When such an optical system is used in a head provided with a plasmon probe, there is an increase in the amount of light that does not contribute to amplification. This requires a light source capable of producing considerably great outputs for a practical use. This, in turn, requires upsizing of the apparatus per se.

As shown in Patent Document 1, in a optical pickup device using a conventional fiber, a 45-degree reflective surface is provided on the end face of the optical fiber so as to bend the optical path. In this case, even if the fiber end face itself is used as the reflective surface, the light beam is diverged in the distance from the reflective surface to the plasmon probe. For this reason, there is a need of additionally installing a condensing member between the fiber and the irradiated surface. This makes it difficult to downsize the pickup device.

The object of the present invention is to solve the aforementioned problems and to provide an optical recording head, magneto-optical recording head, optical recording apparatus, and optical recording apparatus using the magneto-optical recording head characterized by a simple structure and slim configuration; and sufficient efficiency even for a light source with smaller output in the case of a plasmon probe used.

### Means for Solving the Object

Above-mentioned problems are resolved by the following configurations.

1. An optical recording head for recording information on a recording medium by using light, the optical recording head comprising:

a light source section for emitting light;

a slider which is configured to move relative to the recording medium; and

an optical waveguide provided, on the slider, to guide light from the light source section and to irradiate a surface of the recording medium with the light, the optical waveguide having a light emission angle not perpendicular to a surface, of the slider, opposed to a surface of the recording medium.

2. The optical recording head of 1, wherein the optical waveguide is comprised of a material with a refraction index of 2 or higher at a wavelength used therein.

3. The optical recording head of 1 or 2, wherein the optical waveguide changes a spot diameter in such a manner that a spot diameter of outgoing light emitted therefrom is made smaller than a spot diameter of incident light entered from the light source section, and irradiates the recording medium with the outgoing light.

4. The optical recording head of any one of 1 to 3, wherein the light source section includes a linear light guide member for guiding light from a light source to the optical waveguide.

5. The optical recording head of 4, wherein the linear light guide member is connected to the optical waveguide on a lateral side of the slider.

6. The optical recording head of any one of 1 to 5, wherein the light emitted from the light source section has a wavelength in a near-infrared light region.

7. The optical recording head of any one of 1 to 6, further comprising:

a plasmon probe provided, on the optical waveguide at a position at which light is emitted, to generate near-field light.

8. The optical recording head of 7, wherein the plasmon probe includes an antenna or an aperture each having an apex with a radius of curvature of 20 nm or less.

9. The optical recording head of any one of 1 to 8, wherein the light emission angle of the optical waveguide is inclined by from 14° to 45° with respect to a normal line of the light emission surface of the slider.

10. A magneto-optical recording head, comprising:

the optical recording head of any one of 1 to 9; and

a magnetic recording element.

11. An optical recording apparatus, comprising:

the optical recording head of any one of 1 to 9;

a control section for controlling the optical recording head; and

a recording medium.

12. An optical recording apparatus, comprising:

the magneto-optical recording head of 10;

a control section for controlling the magneto-optical recording head; and

a recording medium.

13. An optical recording head for recording information on a recording medium by using light from a light source section, the optical recording head comprising:

a slider which is configured to move relative to the recording medium; and

an optical waveguide provided, on the slider, to guide light from the light source section and to irradiate a surface of the recording medium with the light, the optical waveguide having a light emission angle not perpendicular to a surface, of the slider, opposed to a surface of the recording medium.

14. The optical recording head of 13, wherein the optical waveguide is comprised of a material with a refraction index of 2 or higher at a wavelength used therein.

15. The optical recording head of 13 or 14, wherein the optical waveguide changes a spot diameter in such a manner that a spot diameter of outgoing light emitted therefrom is made smaller than a spot diameter of incident light entered from the light source section, and irradiates the recording medium with the outgoing light.

16. The optical recording head of any one of 13 to 15, further comprising:

a light source section which includes a linear light guide member for guiding light from a light source to the optical waveguide.

17. The optical recording head of 16, wherein the linear light guide member is connected to the optical waveguide on a lateral side of the slider.

18. The optical recording head of any one of 13 to 17, wherein the light which is emitted from the light source section and enters the optical waveguide has a wavelength in a near-infrared light region.

19. The optical recording head of any one of 13 to 18, further comprising:

a plasmon probe provided, on the optical waveguide at a position at which light is emitted, to generate near-field light.

20. The optical recording head of 19, wherein the plasmon probe includes an antenna or an aperture each having an apex with a radius of curvature of 20 nm or less.

21. The optical recording head of any one of 13 to 20, wherein the light emission angle of the optical waveguide is inclined by from 14° to 45° with respect to a normal line of the light emission surface of the slider.

22. A magneto-optical recording head, comprising:

the optical recording head of any one of 13 to 21; and

a magnetic recording element.

23. An optical recording apparatus, comprising:

the optical recording head of any one of 13 to 21;

a control section for controlling the optical recording head; and

a recording medium.

24. An optical recording apparatus, comprising:

the magneto-optical recording head of 22;

a control section for controlling the magneto-optical recording head; and

a recording medium.

### ADVANTAGE OF THE INVENTION

In the present invention, an optical recording head has an optical waveguide mounted on a slider capable of relative movement with respect to a recording medium. This optical waveguide has a light emission angle not perpendicular to the surface, of the slider, opposed to the surface of the recording medium. The incident light from a light source section is guided and is applied to the surface of the recording medium. Therefore, by tilting the light emitting surface of the waveguide, the input end of the waveguide can be positioned on any of the surfaces other than the surface opposed to the surface of the recording medium of the slider. This arrangement allows a fiber to be connected to the waveguide without increase in the head height and to be connected only with a very small space provided. Further, when a plasmon probe is arranged on the light emitting surface of the optical waveguide, the oblique incident light is applied to the plasmon probe, whereby the amplification of light is further increased.

Consequently, the aforementioned arrangement provides an optical recording head, magneto-optical recording head which have a simple structure and are capable of sliming, and which have a sufficient efficiency when using a plasmon probe. An optical recording apparatus using these optical recording head and magneto-optical recording head are also provided.

### BRIEF DESCRIPTION OF THE DRAWINGS

FIG. 1 is a perspective view showing an example of the schematic structure of a light-assisted magnetic recording apparatus;

FIG. 2 is a diagram representing an example of the periphery of a light-assisted magnetic recording head;

FIG. 3 is a cross sectional view representing an example of the periphery of an optical waveguide constituting the light-assisted magnetic recording head, as viewed from the output end;

FIG. 4 is a see-through view representing the optical waveguide of FIG. 3, as viewed from the side;

FIG. 5 is a cross sectional view representing a specific example 1 of the optical waveguide, as viewed from the output end;

FIG. 6 is a see-through view representing the specific example 1 of the optical waveguide, as viewed from the side;

FIG. 7 is a cross sectional view representing a specific example 2 of the optical waveguide, as viewed from the output end;

FIG. 8 is a see-through view representing the specific example 2 of the optical waveguide, as viewed from the side;

FIG. 9 is a cross sectional view representing a specific example 3 of the optical waveguide, as viewed from the output end;

FIG. 10 is a see-through view representing the specific example 3 of the optical waveguide, as viewed from the side;

FIG. 11 is a plan view representing a specific example of a plasmon probe;

FIG. 12 is a cross sectional view representing the process of manufacturing a slider equipped with the specific example 1 of the optical waveguide;

FIG. 13 is a cross sectional view representing the process of forming the core in the specific example 2 of the optical waveguide;

FIG. 14 is a chart representing the relationship of the difference in refractive index Δn between the core and clad;

FIG. 15 is a diagram showing an example of the periphery of the light-assisted magnetic recording head wherein an optical system is used as a light guide member;

FIG. 16 is a diagram showing an example of optical connection with the optical waveguide when an optical system is used as a light guide member;

FIG. 17 is a diagram showing an example wherein a semiconductor laser chip is mounted as a light emitting source directly on the input surface of the optical waveguide;

FIG. 18 is a diagram showing an example of the configuration of an optical waveguide arranged on a slider; and

FIG. 19 is a diagram showing an example of the arrangement of an optical fiber and optical waveguide in a magneto-optical recording head.

### DESCRIPTION OF THE NUMERALS

1. Enclosure

2. Recording disk (recording medium)

3. Magneto-optical recording head

4. Suspension

5. Spindle

6. Tracking actuator

8. Light emitting source (semiconductor laser)

9. Light source section

10. Optical recording apparatus (hard disk apparatus)

11. Slider

12A. Optical waveguide

12B. Magnetic recording element

12C. Magnetic reproducing element

14. Optical fiber (linear light guide member)

21a. Core

24a. Clad

30. Plasmon probe

### BEST MODE FOR CARRYING OUT THE INVENTION

Referring to the drawings, the following describes a light-assisted magnetic recording head, of the present invention, which is an optical recording head provided with a magnetic recording element thereon, and an optical recording apparatus equipped therewith. The same portions which are the same or correspondent in the embodiments are assigned the same reference numerals, and the duplicated descriptions will be omitted in some cases.

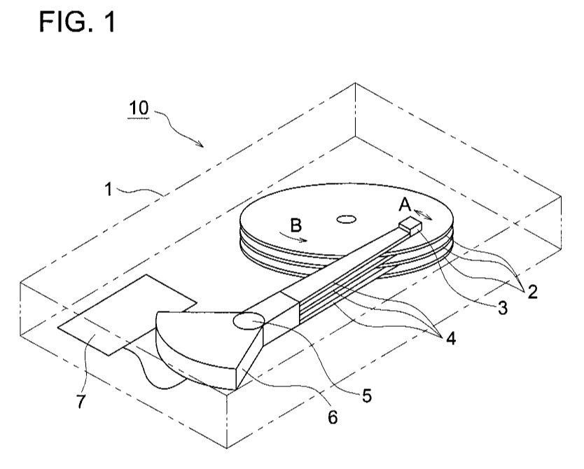

FIG. 1 shows an example of the schematic structure of a light-assisted magnetic recording apparatus (e.g. hard disk apparatus). This optical recording apparatus 10 includes in an enclosure 1: a recording disk 2 (magnetic recording medium), a suspension 4 supported by a spindle 5 as a fulcrum rotatably in the direction of arrow A (tracking direction), a tracking actuator 6 mounted on the suspension 4, a light-assisted magnetic recording head 3 (hereinafter referred to as magneto-optical recording head 3) mounted on an end of the suspension 4, a motor (not illustrated) for rotating the disk 2 in the direction of arrow B, and a control section 7 for controlling the tracking actuator 6, motor and recording operation, and the apparatus 10 is configured to allow the magneto-optical recording head 3 to perform a relative movement above the disk 2 in the floating state.

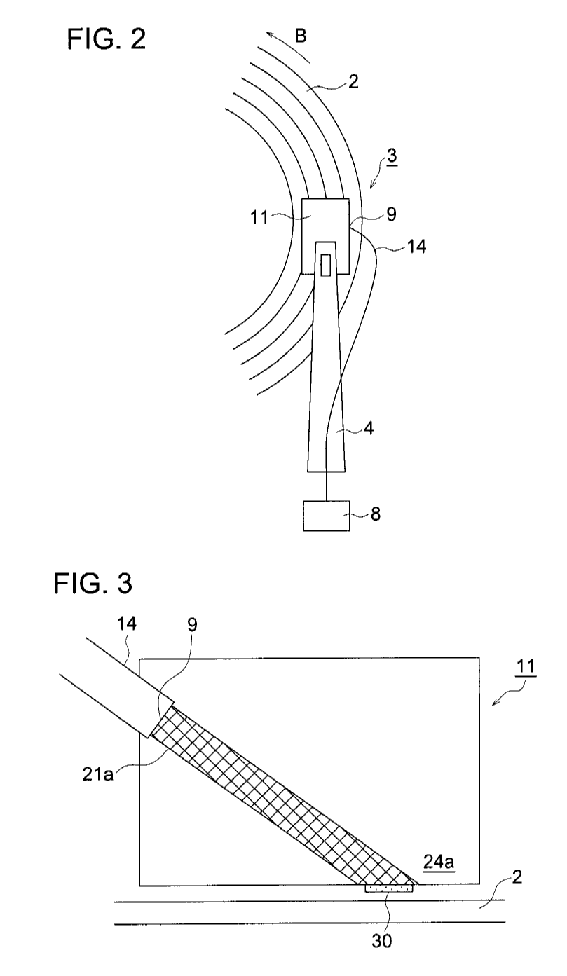

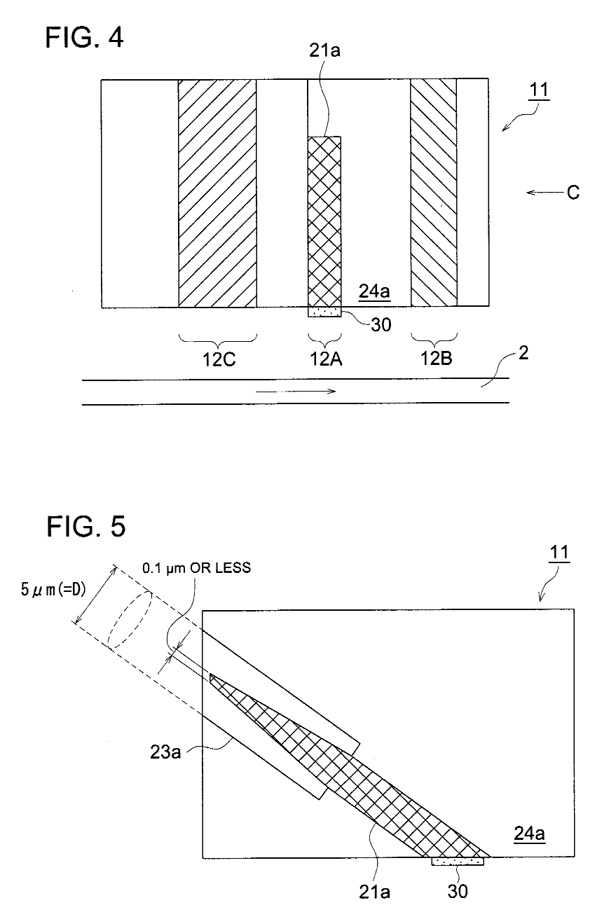

The magneto-optical recording head 3 is a magneto-optical recording head that uses light to record the information on the disk 2. As shown in FIG. 2, the magneto-optical recording head 3 includes an optical fiber 14 as a linear light guide for leading light from a light emitting source to a light source section 9, and a slider 11 performing a relative movement above the magnetic recording medium 2 in a floating state. FIG. 3 and FIG. 4 show an example of the slider 11 of the magneto-optical recording head 3. FIG. 4 is a see-through view when seen from the side wherein the optical fiber 14 is connected to the optical waveguide. FIG. 3 is a cross sectional view when observed from the arrow C of FIG. 4. The slider 11 is provided with an optical waveguide 12A as a light assist section for spot-heating the recording area of the disk 2 by a infrared laser beam, a magnetic recording element 12B as a magnetic recording section for writing magnetic information on the recording area of the disk 2, and a magnetic reproducing element 12C as a magnetic reproducing section for reading the magnetic information recorded on the disk 2.

The semiconductor laser as a light emitting source 8 is a near-infrared light source. The laser beam having a near-infrared wavelength (about 0.8 μm through 2 μm as the near-infrared spectrum, 1000 nm, 1310 nm, and 1550 nm can be specified as the wavelength of a laser beam) is guided to a predetermined position (light source section 9) by the optical fiber 14 as a light guide member. Use of the optical fiber 14 ensures an easy implementation of guiding the light to the side of the slider 11. Moreover, the compact configuration and simple structure of the magneto-optical recording head 3 is ensured because the light from the light emitting source 8 is led to the side of the slider 11 by the optical fiber 14. The near-infrared light emitted from the light source section 9 is led to the optical waveguide 12A to be emitted from the magneto-optical recording head 3 through the optical waveguide 12A. When the near-infrared light emitted from the optical waveguide 12A is applied to the disk 2 in a minute spot, the temperature of the irradiated area of the disk 2 is raised temporarily and the coercive force of the disk 2 is reduced. The magnetic information is written onto the irradiated area, where the coercive force is reduced, by a magnetic recording element 12B.

In FIG. 4, a magnetic reproducing element 12C, the optical waveguide 12A and the magnetic recording element 12B are arranged in that order in the area ranging from the entering side of the recording area of the disk 2 to the exiting side (direction indicated by an arrow in FIG. 4), without the order of arrangement being restricted thereto. It is only required that the magnetic recording element 12B should be located immediately after the exiting side of the optical waveguide 12A. For example, the optical waveguide 12A, magnetic recording element 12B and magnetic reproducing element 12C can be arranged in this order.

The light emitted from the light emitting source 8 (FIG. 2) of a near-infrared laser is received by the optical fiber 14 and is guided to an input end 9 (also the output end of the optical fiber 14) of the optical waveguide 12A. The near-infrared laser beam is guided by the optical waveguide 12A made up of the core 21a (e.g., Si) and clad 24a (e.g., SiO₂) to reach the output end, and the recording area of the disk 2 is directly irradiated.

The core 21a of the optical waveguide 12A is arranged obliquely (not perpendicular to) with respect to the surface of the slider 11 opposed to the surface of the recording area of the disk 2. Because the core 21a is arranged obliquely (non-perpendicularly), the optical fiber for guiding the light to the optical waveguide 12A can be installed in a tilted state with respect to the recording surface of the disk 2. With this arrangement, the position of the input end of the optical waveguide 12A for guiding the light from the optical fiber 14 can be selected freely on any surface other than the slider bottom surface. Further, this arrangement allows connection of the optical fiber 14 with the optical waveguide 12A directly, without increasing the height of the head, and with only a very small space provided for the connection. There is no particular restriction to the angle formed by the optical waveguide 12A with respect to the surface of the slider 11 opposed to the recording surface of the disk 2. The angle can be determined with consideration given to the output of the near-infrared laser beam, the bent state of the optical fiber, the height allowed for the magneto-optical recording head, and the intensity of light required for recording on the disk 2.

The core 21a of the optical waveguide 12A is preferably arranged in a position oblique to the surface of the slider 11 opposed to the disk 2 within the plane approximately perpendicular with respect to the traveling direction of the slider 11. This arrangement allows the aforementioned magnetic recording element 12B and magnetic reproducing element 12C to be easily mounted on the front and rear of the optical waveguide 12A, without interfering with the optical waveguide 12A.

When the plasmon probe 30 (FIG. 3) is mounted on the light emitting surface of the optical waveguide 12A, more minute light spot can be formed. The plasmon that generates a near-field light further increases the amplification of light when the oblique incident light (preferably the light having an angle of greater than the critical level) is applied to the plasmon probe 30, which is a metal chip (to be described later). When the light beam having passed through the optical waveguide 12A tilted with respect to the plasmon probe 30 is applied, almost all the light contributes to achieving greater amplification, with the result that highly efficient plasmon amplification can be achieved. As described above, it is said to be preferable that the optical waveguide 12A is mounted on the slider 11, in the case of the plasmon probe 30 employed, at the angle with which the incident angle of the light onto the light emitting surface of the slider 11 is greater than the critical angle to allow total reflection to occur. When the light beam having a wavelength of about 1.5 μm is employed, silicon and germanium in addition to glass can be used as the optical material of the optical waveguide 12A provided with a plasmon probe serving as the light emitting surface in this example. Silicon and germanium has a refractive index as high as about 3, and a critical angle of about 14 degrees. In the case of glass with refractive index of about 1.5, the critical angle is of the order of 45 degrees. To ensure that the light beam applied to the plasmon probe 30 is amplified with high efficiency, irradiation at about the critical angle is most preferred. For this reason, the light emitting angle of the optical waveguide 12A, when the plasmon probe 30 is provided, is preferably set 15 degrees or greater and 45 degrees or smaller with respect to the normal line of the light emitting surface of the slider 11.

The refractive index, at the used wavelength, of the material forming the core 21a of the optical waveguide 12A is preferably not less than 2. In the case that the optical waveguide 12A made of a core having a high degree of refractive index is used and a clad is arranged around the core 21a or a material that does not permit transmission of the guided light is used, the higher the refractive index of the material forming the core 21a is the more preferable the loss of the guided light. For example, the refractive index is preferably 2 or more, because this is more effective. The upper limit of the refractive index is thought to be limited by the usable material, and the limit is preferably 5 or less from the viewpoint of Fresnel loss.

The following describes Specific Examples 1 through 3 wherein the optical waveguide has a function of reducing the spot diameter of the guided light.

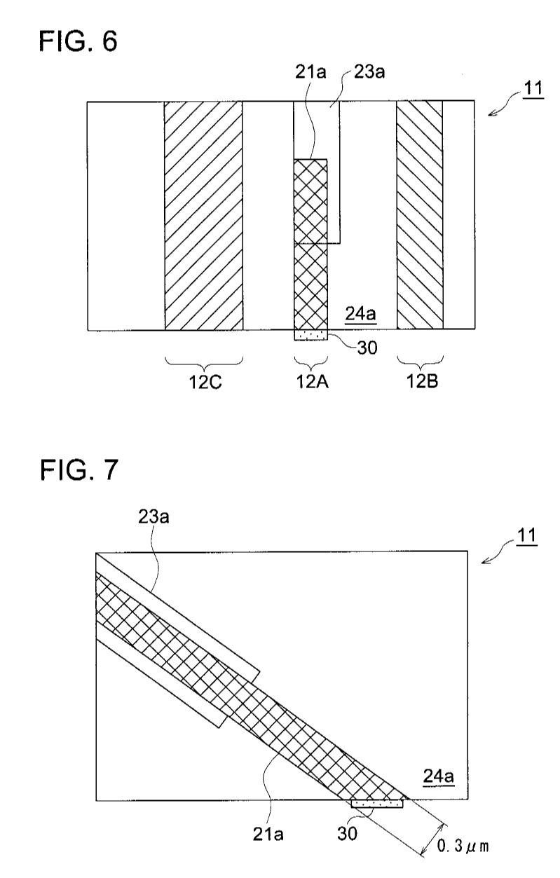

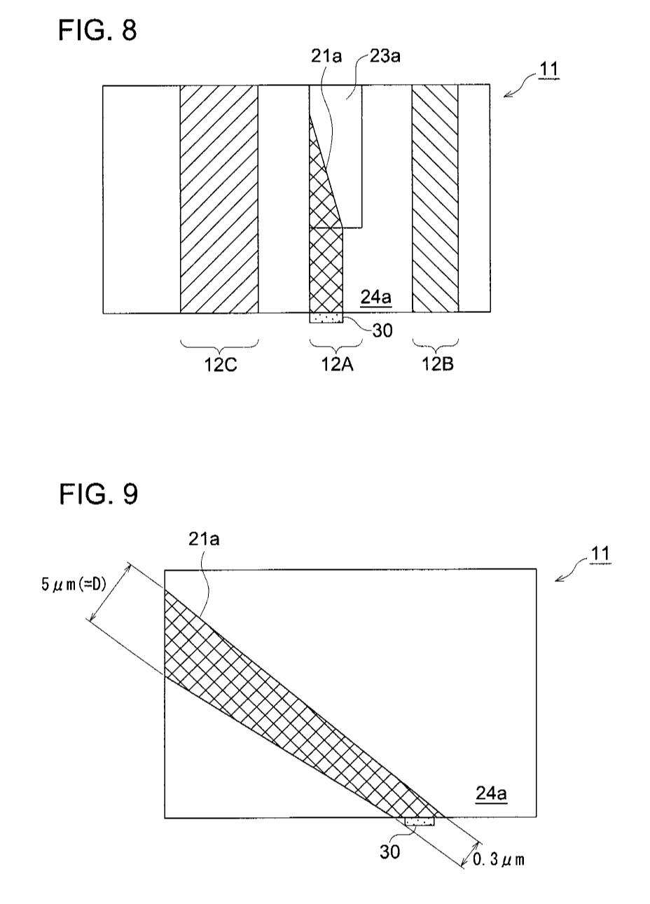

FIGS. 5 and 6 show the Specific Example 1 of the optical waveguide of the slider 11. FIGS. 7 and 8 show the Specific Example 2 of the optical waveguide. FIGS. 5, 7 and 9 are the cross sectional views showing the Specific Examples 1 through 3 as observed from the exiting end side (i.e., the exiting side of the recording area of the disk 2 of FIG. 1. FIGS. 6, 8 and 10 are the see-through views representing the Specific Examples 1 through 3 when observed from the side wherein the optical fiber 14 is connected with the slider 11, as shown in FIG. 2.

The optical waveguide 12A of the Specific Examples 1 and 2 is an optical waveguide made up of a core 21a (e.g., Si), sub-core 23a (e.g., SiON) and clad 24a (e.g., SiO₂). The optical waveguide 12A of the Specific Example 3 is an optical waveguide made up of a core 21a and clad 24a. As shown in FIGS. 5 through 10, a plasmon probe 30 for generating near-field light is arranged at the light emitting position of the optical waveguide or in its vicinity. FIG. 11 shows the Specific Example of the plasmon probe 30.

In FIG. 11, (A) denotes a plasmon probe 30 made up of a triangular flat thin metal film (e.g., aluminum, gold or silver), and (B) indicates a bow tie type flat thin metal film (e.g., aluminum, gold or silver). They are composed of an antenna having a vertex P with an radius of 20 nm or less. (C) indicates a plasmon probe 30 made of a flat thin metal film (e.g., aluminum, gold or silver). It is composed of an antenna having a vertex P with an radius of 20 nm or less. When the plasmon probe 30 is exposed to light, near-field light is produced in the vicinity of the vertex P. This arrangement allows recording to be made by a very small spot of light. To be more specific, when the plasmon probe 30 is arranged at the light emitting position of the optical waveguide 12A or in its vicinity to generate local plasmon, it is possible to reduce the size of the optical spot formed by the optical waveguide. This arrangement is effective in high density recording. In this case, the vertex P of the plasmon probe is preferably located at the center of the core 21a. When the near-infrared wavelength is 1550 nm, gold is preferably used as a thin metal film.

The required spot diameter is about 20 nm when a light assist system is used to perform super high density recording. When consideration is given to the efficiency in the use of light, the mode field (MFD) in the plasmon probe 30 is preferably about 0.3 μm. However, the spot size must be changed about 5 μm to a few hundred nm, because entry of light is difficult with that size. In the Specific Examples 1 through 3, the structure is designed such that a spot size changer, which changes the spot diameter, is constituted of a part of the optical waveguide so as to facilitate the entry of light.

In the see-through view of FIG. 6, the width of the core 21a in Specific Example 1 is constant in the area ranging from the light entering side to the light emitting side. In the cross sectional view of FIG. 5, there is a gradual increase in width from the light entering side to the light emitting side in the sub-core 23a. The mode field diameter is converted by the smooth change of the optical waveguide. To be more specific, in the Specific Example 1, the width of the core 21a of the optical waveguide 12A is 0.1 μm or less on the light entering side and 0.3 μm on the light emitting side. On the light entering side, the optical waveguide 12A having an MFD of about 5 μm is formed by the sub-core 23a. After that, there is gradual light coupling with the core 21a so that the mode field diameter is reduced. In the Specific Example 2, conversely to the Specific Example 2, the film thickness of the core 21a shown in FIG. 8 is increased gradually toward the light emitting side (toward the plasmon probe 30), while the film thickness is not changed in FIG. 7, and thus the mode field diameter is adjusted. As described above, it is preferred that the mode field diameter is converted by a smooth change in the diameter of the optical waveguide so as to satisfy the relationship D>d, where d is the mode field diameter on the light emitting side of the optical waveguide 12A and D is the diameter on the light entering side of the optical waveguide.

In the case that the core of the optical waveguide is tapered (or is gradually thinner) toward the end, when the light transmitting through the core of the optical waveguide enters the core portion of the optical waveguide for spot size conversion, there is an increase in the amount of light leaking to the clad, thereby expanding the electric field distribution of the light, with the result that the spot size is increased. However, if the width or thickness of the core of the optical waveguide is extremely reduced, the transmission mode cannot be present in the optical waveguide, namely, the cut-off state occurs. When this happens, the light is coupled with the optical waveguide composed of the sub-core (SiON) and clad (SiO₂), so that a large light spot is produced. Although the above described in the case of increasing the size of a small light spot, when the light, having the same shape as the light spot, which is enlarged as described above, is entered into the waveguide, the light spot is reduced due to the regressiveness of light. Even if the core is thinned down in only one direction, the light spot can be two-dimensionally enlarged (reduced).

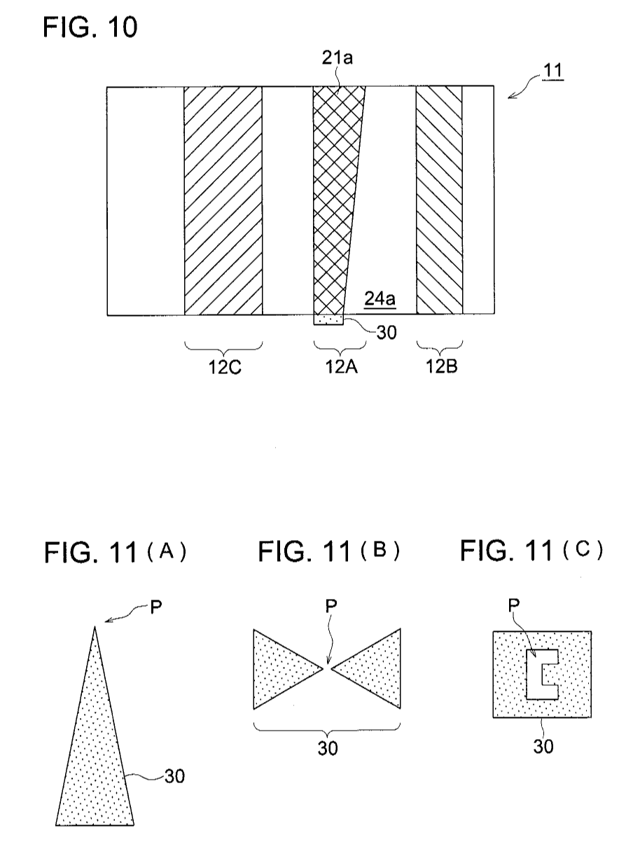

In the Specific Example 3, the width of the core 21a is gradually reduced from the light entering side to the light emitting side in the cross sections in both directions, as shown in FIGS. 9 and 10. To be more specific, the width of the core 21a of the optical waveguide 12A in the Specific Example 3 is 5 μm on the light entering side, and 0.3 μm on the light emitting side, as shown in FIG. 9. The mode field diameter is converted by the smooth change of the optical waveguide 12A. When the core 21a of the optical waveguide 12A is gradually increased in width (or thickness) as described above, the light spot is enlarged based on the shape thereof. If the light having the same shape as the light spot, which is enlarged as described above, is entered in the waveguide, the light spot is reduced due to the regressiveness of light.

The thickness of the slider 11 provided with the optical waveguide 12A is at present considered as about 0.6 mm. Since there is an increasing demand for smaller size, the value is estimated to be further reduced to about 0.2 mm. If the optical waveguide 12A is shortened as the thickness of the slider 11 is reduced, the loss of optical energy is increased when the light spot is reduced by the optical waveguide 12A. For example, assume that the refractive index, at the used wavelength, of the core constituting the optical waveguide 12A is 1.5 (e.g., made of quartz), and the reduction rate by a light spot size converter is ⅕. Then the loss of light energy is about 30%. If the refractive index, at the used wavelength, of the core 21a is 2 or more, the loss of light energy can be preferably kept at 30% or less. Although the upper limit of the refractive index, at the used wavelength, of the core 21a is considered to be limited due to usable material, the upper limit is preferably 5 or less from the viewpoint of Fresnel loss.

In the Specific Examples 1 through 3, the optical waveguide 12A is provided with a core 21a and clad 24a. For example, it is also possible to constitute a optical waveguide without any clad in the Specific Example 3. In this case, the material used around the core must be nontransparent. In this structure, light is guided while being reflected by the interface between the optical waveguide and the member outside the optical waveguide made up of a core. While the light is guided, the light energy is absorbed by the peripheral member at the interface, this absorption causes a loss of light energy. In this case, to minimize the loss of light energy, the refractive index of the core is desired to be high. Alternatively, the light spot converter can be formed by the core alone. Also in this case, when the light spot is reduced and the length of the optical waveguide is reduced as described above, the loss of light energy is increased. To minimize this loss, the refractive index at the wavelength used in the core is preferably 2 or more. Although the upper limit of the refractive index at the wavelength used in the core is considered to be limited due to usable material, the upper limit is preferably 5 or less from the viewpoint of Fresnel loss.

The length of the spot size converter is preferably 0.2 mm or more. This is because light leakage occurs when the spot size is changed in a short range, and therefore a length of 0.2 mm or more is required to reduce this excessive loss. The length of the spot size converter corresponds to the length of the portion wherein the width of the core gradually changes from the light entering side to the light emitting side in the Specific Examples 1 through 3, and corresponds to the length of the sub-core 23a in the Specific Examples 1 and 2. When the optical waveguide 12A is provided in an oblique position, the optical waveguide 12A can be made longer without the thickness of the slider 11 being increased, and thus the spot size converter can also be made longer. Thus, the optical waveguide 12A provided in an oblique position ensures efficient use of the light entering the optical waveguide 12A.

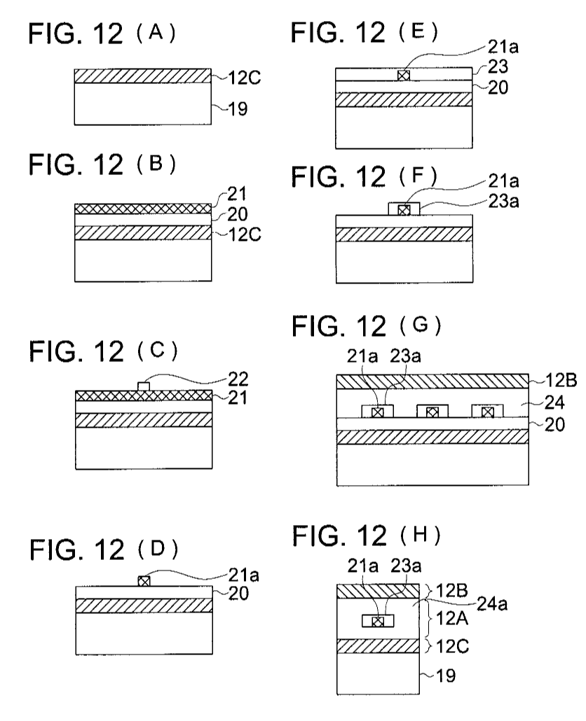

Referring to the process chart of FIG. 12, the following describes the process of manufacturing the slider 11 provided with the optical waveguide 12A of the Specific Example 1. As shown in FIG. 12 (A), after the magnetic reproducing element 12C is provided on a substrate 19 (material: AlTiC, etc.), its surface is planarized. As shown in (B), an SiO₂ layer 20 with a thickness of 3 μm is formed using the CVD method (chemical vapor deposition). This is followed by the step of forming a Si layer 21 having a thickness of 300 nm. This layer is coated with a resist. As shown in (C), the core shape is patterned by the electron beam lithography (or photolithography by exposure to light) to form a resist pattern 22. In this case, a resist pattern is formed so as to ensure that the core is tapered. The Si layer 21 is processed using the RIE method (reactive ion etching), and a core 21a is formed, as shown in (D). An SiON layer 23 with a thickness of 3 μm is laminated using the CVD method as shown in (E), and the SiON layer 23 is processed to be a shape with a width of 3 μm by the photolithography process. A sub-core 23a is whereby formed, as shown in (F). As shown in (G), an SiO₂ layer 24 with a thickness of 5 μm is formed using the CVD method, and after its surface is planarized, a magnetic recording element 12B is provided. After that, an air bearing surface (hereinafter abbreviated as ABS) for enhancement of floating characteristics is processed on the surface opposed to the disk 2. As shown in (H), a cutting process is performed to form the shape of a slider by the machining methods such as dicing and milling. The clad 24a is made up of the SiO₂ layer 20 and SiO₂ layer 24. Although the substrate 19 is made of AlTiC, it can also be made of silicon.

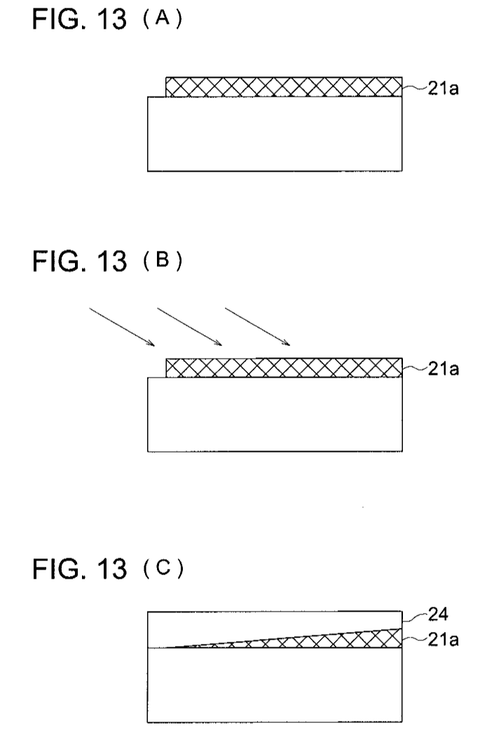

To manufacture the slider 11 having an optical waveguide 12A of the Specific Example 2, after forming the core 21a according to FIG. 12(D) (as in FIG. 13(A)), a tapered shape is created by an oblique etching operation with a dry etching apparatus, as shown in FIG. 13(B). Subsequent to formation of the sub-core 23a of FIG. 12(F), the SiO₂ layer 24 is formed, as shown in FIG. 13(C), whereby the clad 24a is formed (wherein the sub-core 23a in FIG. 13(C) is omitted). To manufacture the slider 11 having an optical waveguide 12A of the Specific Example 3, an oblique etching operation is performed from the direction reverse to that in the oblique etching operation in the Specific Example 2.

As described above, the core of the optical waveguide 12A is preferably made of the material wherein the refractive index at the used wavelength 2 or more. Various kinds of material characterized by a high degree of refractive index have been known. Using these materials with high refractive index can handle various wavelengths ranging from the ultraviolet light to the visible light and near-infrared light and provides a wider choice of the laser and the materials for the optical waveguide 12A. Generally, when the material of high refractive index is processed by a dry etching apparatus, the etching speed is however low, and it is difficult to get a satisfactory selection ratio between these materials and the resist, and therefore there are difficulties in forming a microscopic structure with high performance. For example, visible light can be used for the materials such as GaAs and GaN, but difficulties are involved in processing them. Since processing methods of silicon, which is a commonly used material for semiconductor process, have been established, silicon can be processed with comparative ease. Therefore, it is preferred to use silicon as the material for the core of the optical waveguide. However, when silicon is used as the material for the core of the optical waveguide, visible light cannot be utilized. In this case, near-infrared light is preferably used as the light to be used in the optical waveguide. To be more specific, when the light emitting source which emits the near-infrared wavelength (e.g., 1000 nm, 1310 nm and 1550 nm) as the used wavelength is employed, a widely used silicon can be used as a material of the core, thereby enhancing workability.

The refractive index of silicon is much higher than that of quartz. Therefore, when the silicon is used as the material for an optical waveguide, the difference in refractive index Δn between the core and clad can be increased. This allows formation of a minute spot (i.e., high-energy density) using a simple structure. For example, the core is formed of silicon as described above, and the clad is made of SiO₂. This allows the difference refractive index Δn to be increased. The spot diameter can be reduced to 1 μm or less, further down to 0.5 μm. The spot diameter obtained with the optical waveguide whose core is made of quartz is of the order of 10 μm.

Assuming that the refractive index of the core (e.g., silicon) is n1, and that of the clad is n2, the difference Δn in refractive index between the core and clad (e.g., SiO₂) can be defined by the following formula (1):

Δ(%)=(n1²−n2²)/(2·n1²)×100 (1)

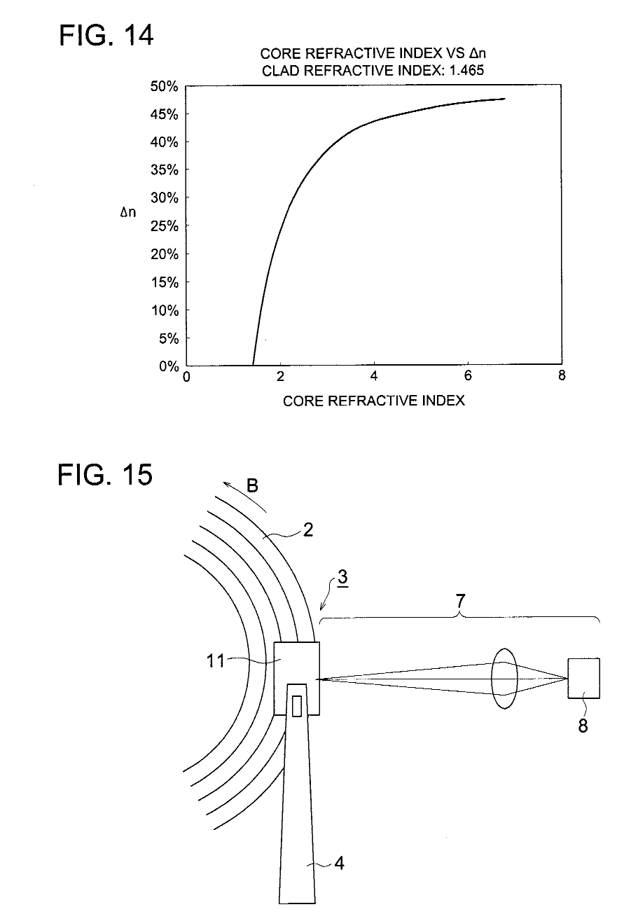

FIG. 14 is a graphic representation showing the relationship between the core refractive index and the difference Δn in refractive index (wherein the clad refractive index is 1.456). Note that the refractive index of SiO₂ is 1.456, that of SiON is 1.5, and that of Si is 3.5.

In the optical waveguide, the difference Δn in refractive index between the core and clad is preferably 20% or more. A minute spot can be obtained using a simple structure, if the optical waveguide with high difference in refractive index, where the difference Δn in refractive index is 20% or more, is employed. Since the beam diameter in the basic mode is 1 μm or less, the difference Δn in refractive index is required to be 20% or more. The difference Δn in refractive index does not exceed 50% This is because the difference Δn in refractive index in the formula (1) only successively approximates 50%, however high the core refractive index is.

As described above, silicon is a core material that can be effectively used for near-infrared wavelength. When processing advantages are not required, it is possible to use other materials of high refractive index wherein the refractive index is 2 or more. These materials effectively provide a minute spot having wavelengths in a wide spectrum ranging from ultraviolet light to visible light and near-infrared light. The materials of high refractive index other than silicon (refractive index: wavelength range) are exemplified by diamond (2.4: entire visible range), group III-V semiconductor: AlGaAs (3.5: near-infrared light through red), GaN (2.6: green, blue), GaAs (3.58: red, orange and blue), GaP (3.29: red, yellow, green), AlGaInP (3.5; orange, yellow, green), and Group II-VI semiconductor: ZnSe (2.4: blue). Further, the method of processing the materials of high refractive index other than silicon can be exemplified by dry etching by O₂ gas for diamonds, and dry etching by an ICP etching apparatus using Cl₂ gas or methane hydrogen for the GaAs, GaP, ZnSe, GaN and related substances.

As described above, the disk apparatus such as a hard disk apparatus generally uses a plurality of recording disks to meet the requirements for higher capacity. In this case, the magneto-optical recording head is required to be thin enough to move between them. Even when a plurality of recording disks are not used, the space between the wall of the enclosure and the disk is limited in a compact hard disk apparatus and others. This requires the optical recording head to be thin enough also for these apparatuses. In this case the space is about 1 mm.

In the aforementioned magneto-optical recording head 3, a larger light spot is used on the light entering side than on the light emitting side by using a spot size converter. This arrangement provides a minute light spot as well as rough tolerance for assembling the slider and optical fiber as a light guide member because of the larger light spot on the light entering side. This is advantageous for assembling.

From the above, it follows that the mode field diameter is preferably changed to meet the following relationship by smoothly changing the diameter of the optical waveguide, where the relationship is D>d, wherein the mode field diameter on the light emitting side of the optical waveguide 12A is d and that on the light entering side of the optical waveguide 12A is D. In the Specific Example 1, D=5 μm, and d=0.3 μm, for instance (FIG. 5). A small light spot can be obtained, when the mode field diameter is changed by smoothly changing the diameter of the optical waveguide so that the mode field diameter on the light emitting side of the optical waveguide 12A is smaller than that on the light entering side of the optical waveguide 12A. If the light spot size can be reduced, the recording density can be increased. The upper limit of magnification rate can be estimated as 40 times based on the basic manufacturing problems (the limited maximum light spot size that can be expanded, and the limited minimum light spot size that can be generated), and the practically required magnification rate (size on the light emitting side: 0.25 μm, size on the light entering side: 0.3 μm). Therefore, the mode field diagram more preferably meets the relationship 40d>D>d.

The maximum height of the magneto-optical recording head 3 is preferably smaller than the distance between the disk and a member (such as the enclosure housing the disk and slider, or the second disk for recording). The optical recording apparatus 10 of FIG. 1 can have a structure where an optical waveguide for writing information onto the disk 2 is provided, and the maximum height of the magneto-optical recording head 3, which is made up of a combination of a relatively movable slider 11 (FIG. 2, etc.) floating above the disk 2 and an optical fiber 14 as a light guide member, is smaller than the distance between the enclosure 1 arranged so as to cover the traveling path of the slider 11 and the disk 2, or is smaller than the distance between the adjacent second disk. This structure provides a compact configuration of the optical recording apparatus 10.

The aforementioned magneto-optical recording head 3 is a light-assisted magneto-optical recording head that uses light to record information on the disk 2. However, it is not restricted to the light-assisted magneto-optical recording head, as long as it is an optical recording head that uses light to record information on a recording medium, and is provided with a slider that performs a relative movement above the recording medium in a floating state, and an optical waveguide 12A wherein the refractive index of the core is 2 or more. For example, the same advantages are offered by an optical recording head designed for recording such as near-infrared light recording and phase-changing recording, using the optical waveguide provided with the aforementioned characteristics. Such a magneto-optical recording head is designed to perform optical recording without using magnetism. It has the same structure as that of the slider 11 constituting the magneto-optical recording head 3 shown in the Specific Example 1 (FIG. 4), except that the magnetic reproducing element 12C and magnetic recording element 12B are not provided. The aforementioned plasmon probe 30 can be installed at the light emitting position of the optical waveguide 12A or in the vicinity thereof. It is possible to use an optical recording apparatus 10 wherein the magneto-optical recording head 3 shown in FIG. 1 is replaced by the light-assisted magneto-optical recording head.

In FIG. 2, the optical fiber 14 as a light guide member, which guides the light from the light emitting source 8 toward the light source section 9, is used in the optical waveguide of the slider 11. In this case, the connection of the optical fiber 14 and the optical waveguide can be done in such a manner that their axes are aligned in line and the optical fiber is mounted obliquely on the side of the slider by use of its flexibility. Assume that the space between the wall of the enclosure and the disk or between the disks is 1 mm, for example, because the thickness of the slider 11 having an optical waveguide can be about 0.4 mm, it can be mounted sufficiently within the space of 1 mm even if the optical fiber 14 is mounted obliquely on the slider 11 being gently bent.

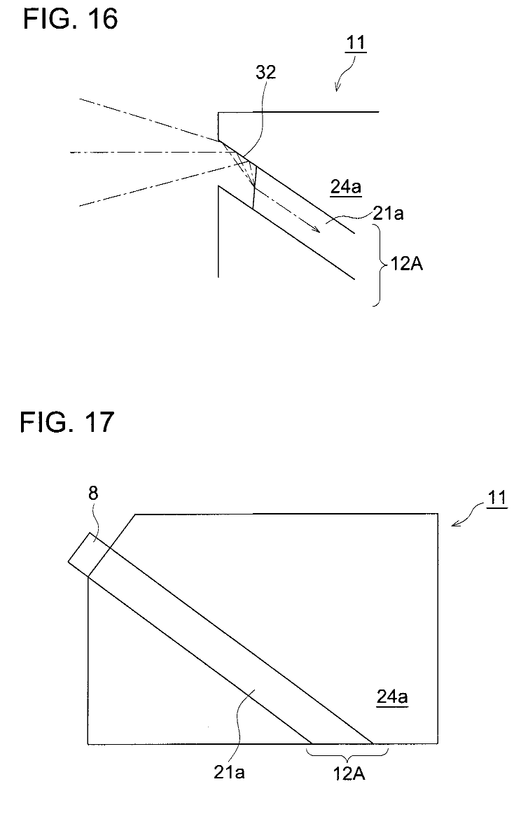

Instead of the optical fiber 14, a light guiding optical system 7 (including the light emitting source 8) such as a lens, shown in FIG. 15, can be used as the light guide member that guides light from the light emitting source 8 toward the light source section 9. When the optical system such as a lens is used, it is preferred to condense the light beam onto the light entering surface of the optical waveguide, using the light guiding optical system 7 which is not integrally formed with the slider 11. To put it more specifically, to condense the light beam into the light entering surface of the optical waveguide always in conformity to the movement of the magneto-optical recording head 3, the light guiding optical system 7 is provided with an actuator for adjusting the light emitting angle (not illustrated) and the condensing position (focus), or a link mechanism is installed between the light guiding optical system 7 and the suspension that supports the magneto-optical recording head 3, whereby the light emitting angle and light condensing position (focus) are adjusted. In this case, the slider 11 is preferably provided with a light reflecting surface 32 at the light entering portion of the optical waveguide 12A, as shown in FIG. 16. This arrangement allows the light guiding optical system 7 with the optical axis parallel to the recording surface of the light guiding optical system 7 to be available. This makes it possible to cope with the situation that the space for the optical waveguide to fit in such as the space between the wall of the enclosure and the disk or between disks is narrow.

As shown in FIG. 17, a light emitting source 8, for example, a semiconductor laser chip may be attached directly to the slider 11 so that the light emitting portion is photo-coupled with the light entering surface of the core 21a of the optical waveguide 21A.

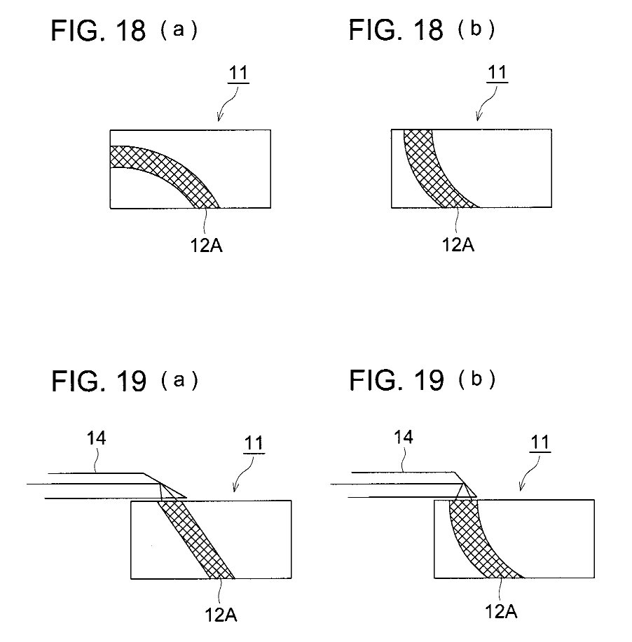

Although the optical waveguide 12A arranged on the slider 11 described so far is designed in a linear shape, it is also possible to arrange such a configuration that the optical waveguide 12A is tilted to the surface of the recording medium on the light beam emitting surface on the bottom of the slider 11, and is gently bent between the light beam emitting surface and light beam entering surface, as shown in FIGS. 18(a) and (b).

When the height of the magneto-optical recording head 3 is about 1 mm, it is also possible to adopt such a structure that the end face of the optical fiber 14 is cut obliquely, as shown in FIGS. 19(a) and (b), and the light beam is bent using the total reflection on the cut surface so as to be coupled with the optical waveguide 12A. Further, the optical waveguide 12A mounted on the slider 11 may include a spot size conversion structure.

1. An optical recording head for recording information on a recording medium by using light, the optical recording head comprising:
a light source section for emitting light, the light source section including:
a linear light guide member for guiding light entered therein from the light source;
a slider which is configured to move relative to the recording medium;
an optical waveguide provided on the slider with a first end thereof located at a light emission surface, of the slider, opposed to a surface of the recording medium, the optical waveguide receiving on a second end thereof light which has been emitted from the light source section after being guided by the linear light guide member, then guiding the received light, and emitting the received light, from the first end at a light emission angle not perpendicular to the light emission surface, to irradiate the surface of the recording medium; and
a plasmon probe provided on the first end of the optical waveguide to generate near-field light,
wherein the linear light guide member is connected to the optical waveguide on a lateral side of the slider.

2. The optical recording head of claim 1, wherein the optical waveguide is comprised of a material with a refraction index of 2 or higher at a wavelength used therein.

3. The optical recording head of claim 1, wherein the optical waveguide changes a spot diameter in such a manner that a spot diameter of outgoing light emitted therefrom is made smaller than a spot diameter of incident light entered from the light source section, and irradiates the recording medium with the outgoing light.

4. (canceled)

5. (canceled)

6. The optical recording head of claim 1, wherein the light emitted from the light source section has a wavelength in a near-infrared light region.

7. (canceled)

8. The optical recording head of claim 1, wherein the plasmon probe includes an antenna or an aperture each having an apex with a radius of curvature of 20 nm or less.

9. The optical recording head of claim 1, wherein the light emission angle of the optical waveguide is inclined by from 14° to 45° with respect to a normal line of the light emission surface of the slider.

10. A magneto-optical recording head for recording information on a recording medium by using light, the magneto-optical recording head comprising:
a light source section for emitting light, the light source section including:
a linear light guide member for guiding light entered therein from the light source;
a slider which is configured to move relative to the recording medium;
an optical waveguide provided on the slider with a first end thereof located at a light emission surface, of the slider, opposed to a surface of the recording medium, the optical waveguide receiving on a second end thereof light which has been emitted from the light source section after being guided by the linear light guide member, then guiding the received light, and emitting the received light, from the first end at a light emission angle not perpendicular to the light emission surface, to irradiate the surface of the recording medium;
a plasmon probe provided on the first end of the optical waveguide to generate near-field light; and
a magnetic recording element provided on the slider to record information on the recording medium,
wherein the linear light guide member is connected to the optical waveguide on a lateral side of the slider.

11. An optical recording apparatus, comprising:
a recording medium;
an optical recording head for recording information on the recording medium by using light, the optical recording head including:
a light source section for emitting light, the light source section having:
a linear light guide member for guiding light entered therein from a light source;
a slider which is configured to move relative to the recording medium;
an optical waveguide provided on the slider with a first end thereof located at a light emission surface, of the slider, opposed to a surface of the recording medium, the optical waveguide receiving on a second end thereof light which has been emitted from the light source section after being guided by the linear light guide member, then guiding the received light, and emitting the received light, from the first end at a light emission angle not perpendicular to the light emission surface, to irradiate the surface of the recording medium; and
a plasmon probe provided on the first end of the optical waveguide to generate near-field light;
a control section for controlling the optical recording head,
wherein the linear light guide member is connected to the optical waveguide on a lateral side of the slider.

12. An optical recording apparatus, comprising:
a recording medium;
a magneto-optical recording head for recording information on the recording medium by using light, the magneto-optical recording head including:
a light source section for emitting light, the light source section having:
a linear light guide member for guiding light entered therein from a light source;
a slider which is configured to move relative to the recording medium;
an optical waveguide provided on the slider with a first end thereof located at a light emission surface, of the slider, opposed to a surface of the recording medium, the optical waveguide receiving on a second end thereof light which has been emitted from the light source section after being guided by the linear light guide member, then guiding the received light, and emitting the received light, from the first end at a light emission angle not perpendicular to the light emission surface, to irradiate the surface of the recording medium;
a plasmon probe provided on the first end of the optical waveguide to generate near-field light; and
a magnetic recording element provided on the slider to record information on the recording medium,
a control section for controlling the magneto-optical recording head,
wherein the linear light guide member is connected to the optical waveguide on a lateral side of the slider.

13. An optical recording head for recording information on a recording medium by using light from a light source section which has a linear light guide member for guiding light entered therein from a light source, the optical recording head comprising:
a slider which is configured to move relative to the recording medium;
an optical waveguide provided on the slider with a first end thereof located at a light emission surface, of the slider, opposed to a surface of the recording medium, the optical waveguide receiving on a second end thereof light which has been emitted from the light source section after being guided by the linear light guide member, then guiding the received light, and emitting the received light, from the first end at a light emission angle not perpendicular to the light emission surface, to irradiate the surface of the recording medium; and
a plasmon probe provided on the first end of the optical waveguide to generate near-field light,
wherein the linear light guide member is connected to the optical waveguide on a lateral side of the slider.

14. The optical recording head of claim 13, wherein the optical waveguide is comprised of a material with a refraction index of 2 or higher at a wavelength used therein.

15. The optical recording head of claim 13, wherein the optical waveguide changes a spot diameter in such a manner that a spot diameter of outgoing light emitted therefrom is made smaller than a spot diameter of incident light entered from the light source section, and irradiates the recording medium with the outgoing light.

16. (canceled)

17. (canceled)

18. The optical recording head of claim 13, wherein the light which is emitted from the light source section and enters the optical waveguide has a wavelength in a near-infrared light region.

19. (canceled)

20. The optical recording head of claim 13, wherein the plasmon probe includes an antenna or an aperture each having an apex with a radius of curvature of 20 nm or less.

21. The optical recording head of claim 13, wherein the light emission angle of the optical waveguide is inclined by from 14° to 45° with respect to a normal line of the light emission surface of the slider.

22. A magneto-optical recording head for recording information on a recording medium by using light from a light source section which has a linear light guide member for guiding light entered therein from a light source, the magneto-optical recording head comprising:
a slider which is configured to move relative to the recording medium;
an optical waveguide provided on the slider with a first end thereof located at a light emission surface, of the slider, opposed to a surface of the recording medium, the optical waveguide receiving on a second end thereof light which has been emitted from the light source section after being guided by the linear light guide member, then guiding the received light, and emitting the received light, from the first end at a light emission angle not perpendicular to the light emission surface, to irradiate the surface of the recording medium;
a plasmon probe provided on the first end of the optical waveguide to generate near-field light; and
a magnetic recording element provided on the slider to record information on the recording medium,
wherein the linear light guide member is connected to the optical waveguide on a lateral side of the slider.

23. An optical recording apparatus, comprising:
a recording medium;
an optical recording head for recording information on a recording medium by using light from a light source section which has a linear light guide member for guiding light entered therein from a light source, the optical recording head including:
a slider which is configured to move relative to the recording medium;
an optical waveguide provided on the slider with a first end thereof located at a light emission surface, of the slider, opposed to a surface of the recording medium, the optical waveguide receiving on a second end thereof light which has been emitted from the light source section after being guided by the linear light guide member, then guiding the received light, and emitting the received light, from the first end at a light emission angle not perpendicular to the light emission surface, to irradiate the surface of the recording medium; and
a plasmon probe provided on the first end of the optical waveguide to generate near-field light;
a control section for controlling the optical recording head,
wherein the linear light guide member is connected to the optical waveguide on a lateral side of the slider.

24. An optical recording apparatus, comprising:
a recording medium,
a magneto-optical recording head for recording information on the recording medium by using light from a light source section which has a linear light guide member for guiding light entered therein from a light source, the magneto-optical recording head including:
a slider which is configured to move relative to the recording medium;
an optical waveguide provided on the slider with a first end thereof located at a light emission surface, of the slider, opposed to a surface of the recording medium, the optical waveguide receiving on a second end thereof light which has been emitted from the light source section after being guided by the linear light guide member, then guiding the received light, and emitting the received light, from the first end at a light emission angle not perpendicular to the light emission surface, to irradiate the surface of the recording medium;
a plasmon probe provided on the first end of the optical waveguide to generate near-field light; and
a magnetic recording element provided on the slider to record information on the recording medium;
a control section for controlling the magneto-optical recording head,
wherein the linear light guide member is connected to the optical waveguide on a lateral side of the slider.
